(19) United States
(12) Patent Application Publication
(10) Pub. No.: US 2025/0338054 A1
(43) Pub. Date: Oct. 30, 2025

(54) EARMUFF DEVICE AND NOISE REDUCTION ADJUSTMENT METHOD

(71) Applicant: Lanto Electronic Limited, Kunshan City (CN)

(72) Inventors: Hsin-Nan CHEN, Taipei City (TW); Tsung-Pao HSU, Taipei City (TW); Jung-Pin CHIEN, Taipei City (TW); Yao-Chun TSAI, Taipei City (TW); Che-Yung HUANG, Taipei City (TW)

(73) Assignee: Lanto Electronic Limited, Kunshan City (CN)

(21) Appl. No.: 19/193,408

(22) Filed: Apr. 29, 2025

(30) Foreign Application Priority Data
Apr. 30, 2024 (CN) 202410535765.9

(51) Int. Cl. H04R 1/10

(52) U.S. Cl. CPC H04R 1/1008; H04R 1/1083

(57) ABSTRACT

Disclosed is an earmuff device, which is applied to a headphone and includes a housing with an accommodation cavity, a sensing plate, a microphone unit and a processor. The sensing plate is disposed in the accommodation cavity, and provided with sensors. Each sensor is configured to generate a sensing signal according to a relative distance and/or a pressure between each sensor and an ear portion of a user when the headphone is in a wearing state. The microphone unit is disposed in the accommodation cavity and configured to obtain a noise signal. The processor is disposed in the accommodation cavity, and configured to obtain sensing amounts of the sensors based on the sensing signals generated by the sensors, and adjust a gain value of the microphone unit based on a magnitude relationship between the sensing amounts of the sensors and a preset value.

### CROSS REFERENCE TO RELATED PRESENT DISCLOSURE

This application claims the priority benefit of Chinese Patent Application Serial Number 202410535765.9, filed on Apr. 30, 2024, the full disclosure of which is incorporated herein by reference.

### TECHNICAL FIELD

The present disclosure relates to the technical field of headphone, in particular to an earmuff device and a noise reduction adjustment method.

### RELATED ART

Current headphones usually use active noise reduction (ANR) technology to reduce the impact of environmental noise on human ears.

In the use process of the headphone, if the headphone is not worn properly, sound leakage may occur, thereby affecting the active noise reduction effect. However, it is difficult for users to perceive whether there is sound leakage when wearing the headphone, and requiring the user to repeatedly adjust the wearing state of the headphone to achieve a better active noise reduction effect will affect the user's experience.

### SUMMARY

The present disclosure provides an earmuff device, which is applied to a headphone. The earmuff device includes a housing with an accommodation cavity, a sensing plate, a microphone unit and a processor. The sensing plate is disposed in the accommodation cavity, the sensing plate is provided with a plurality of sensors distributed at different positions, and each sensor is configured to generate a sensing signal according to a relative distance and/or a pressure between each sensor and an ear portion of a user when the headphone is in a wearing state. The microphone unit is disposed in the accommodation cavity and is configured to obtain a noise signal. The processor is disposed in the accommodation cavity and is connected to the plurality of sensors and the microphone unit, and the processor is configured to obtain sensing amounts of the plurality of sensors based on the sensing signals generated by the plurality of sensors, and adjust a gain value of the microphone unit based on a magnitude relationship between the sensing amounts of the plurality of sensors and a preset value, so as to determine a current intensity of active noise reduction.

The present disclosure provides a noise reduction adjustment method, which is applied to an earmuff device of a headphone. The noise reduction adjustment method comprises the following steps: obtaining sensing amounts of a plurality of sensors based on sensing signals generated by the plurality of sensors distributed on a sensing plate according to relative distances and/or pressures between the plurality of sensors and an ear portion of a user when the headphone is in a wearing state; and adjusting a gain value of a microphone unit used to obtain a noise signal based on a magnitude relationship between the sensing amounts of the plurality of sensors and a preset value, thereby determining a current intensity of active noise reduction.

### BRIEF DESCRIPTION OF THE DRAWINGS

Accompanying drawings described herein are intended to provide a further understanding of the present disclosure and form a part of the present disclosure, and exemplary embodiments of the present disclosure and descriptions thereof are intended to explain the present disclosure but are not intended to unduly limit the present disclosure. In the drawings:

FIG. 1 is a structural schematic diagram of a headphone according to an embodiment of the present disclosure;

FIG. 2 is a schematic diagram of a user wearing the headphone of FIG. 1;

FIG. 3 is a circuit block diagram of an embodiment of the earmuff device of FIG. 1;

FIG. 4 is a top view of an embodiment of the sensing plate of the present disclosure;

FIG. 5 is a circuit block diagram of another embodiment of the earmuff device of FIG. 1;

FIG. 6 is a flow chart of a noise reduction adjustment method according to an embodiment of the present disclosure;

FIG. 7 is a flow chart of a noise reduction adjustment method according to another embodiment of the present disclosure; and

FIG. 8 is a flow chart of a noise reduction adjustment method according to still another embodiment of the present disclosure.

### DETAILED DESCRIPTION OF THE EMBODIMENTS

The embodiments of the present disclosure will be described below in conjunction with the relevant drawings. In the figures, the same reference numbers refer to the same or similar components or method flows.

It must be understood that the words “including”, “comprising” and the like used in this specification are used to indicate the existence of specific technical features, values, method steps, work processes, elements and/or components. However, it does not exclude that more technical features, values, method steps, work processes, elements, components, or any combination of the above can be added.

It must be understood that when an element is described as being “connected” or “coupled” to another element, it may be directly connected or coupled to another element, and intermediate elements therebetween may be present. In contrast, when an element is described as “directly connected” or “directly coupled” to another element, there is no intervening element therebetween.

In prior art, how to perform automatic noise reduction adjustment according to the actual wearing state of the headphone is a technical problem.

The embodiments of the present disclosure provide an earmuff device and a noise reduction adjustment method. At least an embodiment can solve the problem that the active noise reduction effect of the existing headphone cannot be automatically adjusted according to the actual wearing state of the headphone.

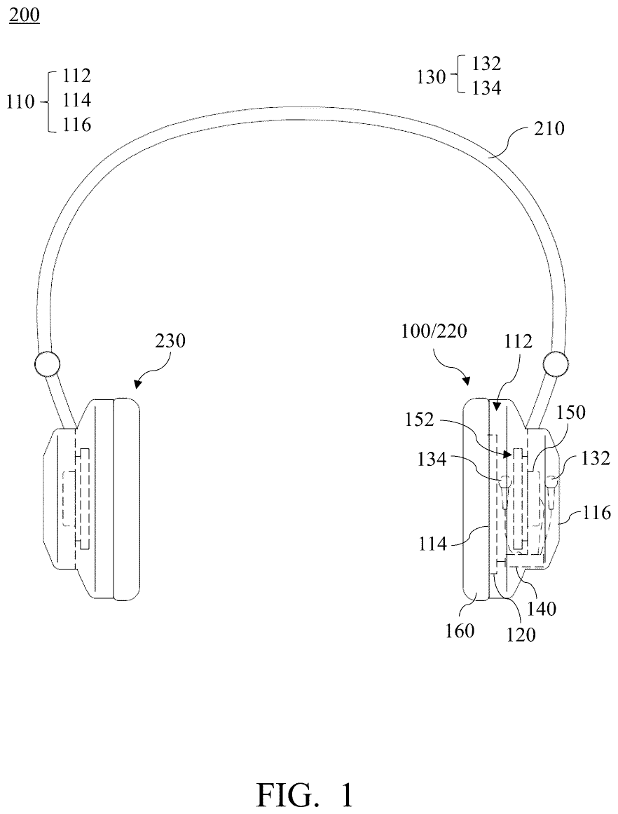

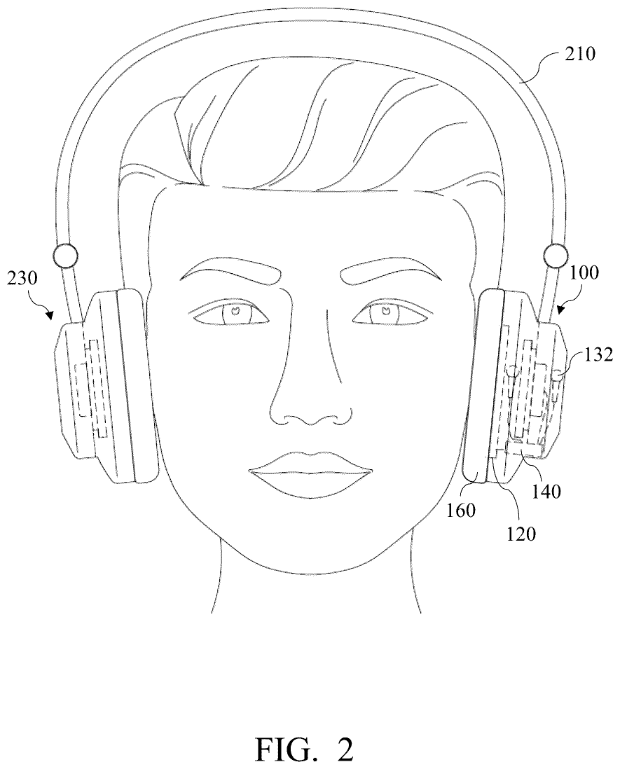

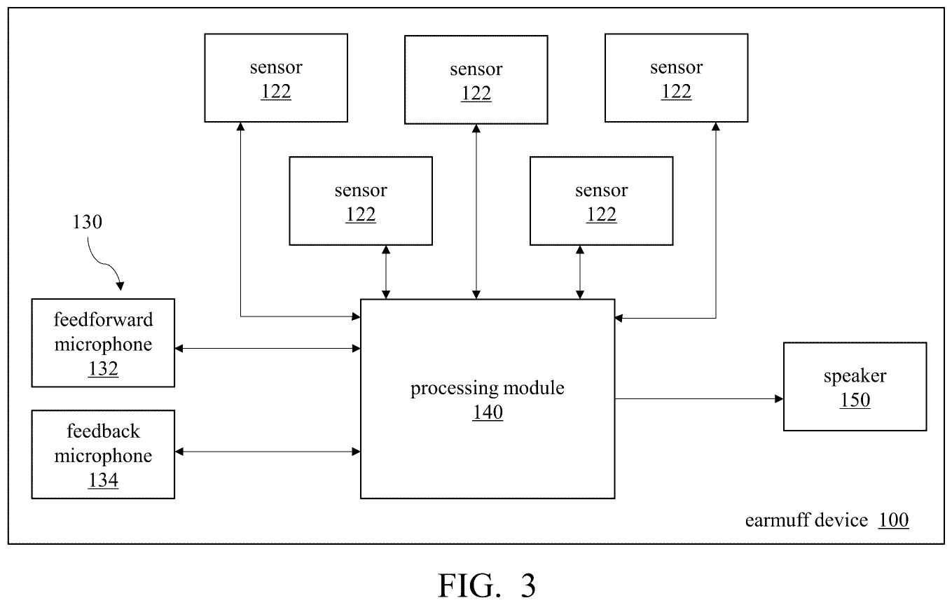

Please refer to FIG. 1 to FIG. 3, FIG. 1 is a structural schematic diagram of a headphone according to an embodiment of the present disclosure, FIG. 2 is a schematic diagram of a user wearing the headphone of FIG. 1, and FIG. 3 is a circuit block diagram of an embodiment of the earmuff device of FIG. 1. As shown in FIG. 1 to FIG. 3, a headphone 200 comprises a bracket 210 and a left earmuff 220 and a right earmuff 230 connected to two ends of the bracket 210. The left earmuff 220 and/or the right earmuff 230 may be an earmuff device 100. In this embodiment, only the left earmuff 220 is the earmuff device 100, but this embodiment is not intended to limit the present disclosure.

The earmuff device 100 comprises a housing 110 with an accommodation cavity 112, a sensing plate 120, a microphone unit 130 and a processor 140. The housing 110 may comprise a front cover 114 and a rear cover 116, and the front cover 114 and the rear cover 116 enclose the accommodation cavity 112, wherein the front cover 114 is located on the side of the housing 110 that contacts an ear portion of a user. In addition, the front cover 114 may be provided with a plurality of sound output holes (not shown).

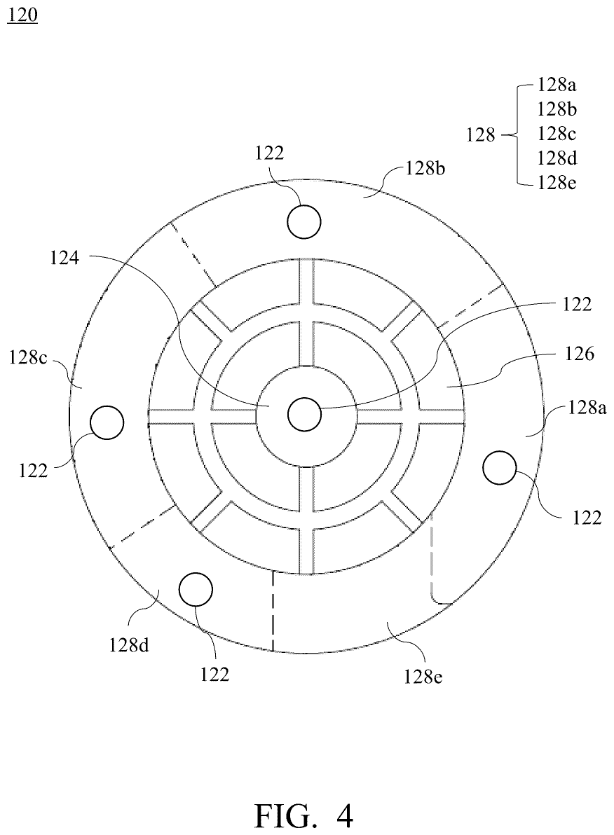

The sensing plate 120 is disposed in the accommodation cavity 112, the sensing plate 120 is provided with a plurality of sensors 122 distributed at different positions, the plurality of sensors 122 correspond to the ear portion of the user when the headphone 200 is in a wearing state, and the ear portion comprises the ear or comprises the ear and the part of the head surrounding the ear. Each sensor 122 is configured to generate a sensing signal according to a relative distance and/or a pressure between each sensor and the ear portion of the user when the headphone 200 is in the wearing state (that is, the sensor 122 may comprise a touch sensor for detecting the relative distance between it and the ear portion of the user and/or a pressure sensor for detecting the pressure), as shown in FIG. 4, which is a top view of an embodiment of the sensing plate of the present disclosure. The sensor 122 may be, but is not limited to, a capacitive sensor; when a metal or a conductor (e.g., human skin) approaches or contacts the sensor 122, the capacitance of the sensor 122 changes; the closer the relative distance between the sensor 122 and the ear portion of the user, the greater the magnitude of the sensing signal generated by the sensor 122; the farther the relative distance between the sensor 122 and the ear portion of the user, the smaller the magnitude of the sensing signal generated by the sensor 122.

In some embodiments, the sensor 122 may be, but is not limited to, a pressure sensor; under a circumstance in which the human skin directly contacts the sensor 122 or indirectly contacts the sensor 122 through a pad material, when the pressure of the contact part between the human skin and the sensor 122 changes, the sensing amount of the sensor 122 also changes. The greater the pressure between the sensor 122 and the ear portion of the user, the greater the magnitude of the sensing signal generated by the sensor 122; the smaller the pressure between the sensor 122 and the ear portion of the user, the smaller the magnitude of the sensing signal generated by the sensor 122. The pressure may come from the elastic force of the bracket 210. For example, when a user with a larger head circumference wears the earmuff device 100, the bracket 210 is elastically deformed to a greater extent, and the elastic force generated is greater, so that the pressure between the sensor 122 and the ear portion of the user is greater, otherwise the pressure is smaller. Alternatively, when the user wears the headphone 200, the outer side of the left earmuff 220 and/or the right earmuff 230 of the earmuff device 100 may be subjected to external pressure, for example, the user applies pressure to the outer side of the left earmuff 220 and/or the right earmuff 230 of the earmuff device 100 with his/her hand or rests his/her head on an external object, which may also increase the pressure between the sensor 122 and the ear portion of the user.

The microphone unit 130 is disposed in the accommodating cavity 112 and is configured to obtain a noise signal. The processor 140 is disposed in the accommodating cavity 112 and is connected to the plurality of sensors 122 and the microphone unit 130. The processor 140 is configured to obtain sensing amounts of the plurality of sensors 122 based on the sensing signals generated by the plurality of sensors 122, and adjust a gain value of the microphone unit 130 based on a magnitude relationship between the sensing amounts of the plurality of sensors 122 and a preset value, thereby determining a current intensity of active noise reduction. The greater the gain value of the microphone unit 130, the stronger the intensity of active noise reduction; the smaller the gain value of the microphone unit 130, the weaker the intensity of active noise reduction. The preset value can be adjusted according to actual needs.

Therefore, the earmuff device 100 determines the wearing tightness, closeness and/or pressure of the headphone 200 (that is, the earmuff device 100 determines the actual state of the headphone when it is worn on the ear portion) through the sensing amounts of the plurality of sensors 122, and automatically adjusts the gain value of the microphone unit 130 to improve the active noise reduction effect of the headphone 200. It should be noted that, because the sensor 122 cannot distinguish whether the object is a human ear or a metal object, the processor 140 can determine the tightness of the headphone 200 through the plurality of sensors 122 when determining that the headphone 200 is in the wearing state, thereby effectively avoiding misjudgment caused by placing the headphone 200 on a metal object.

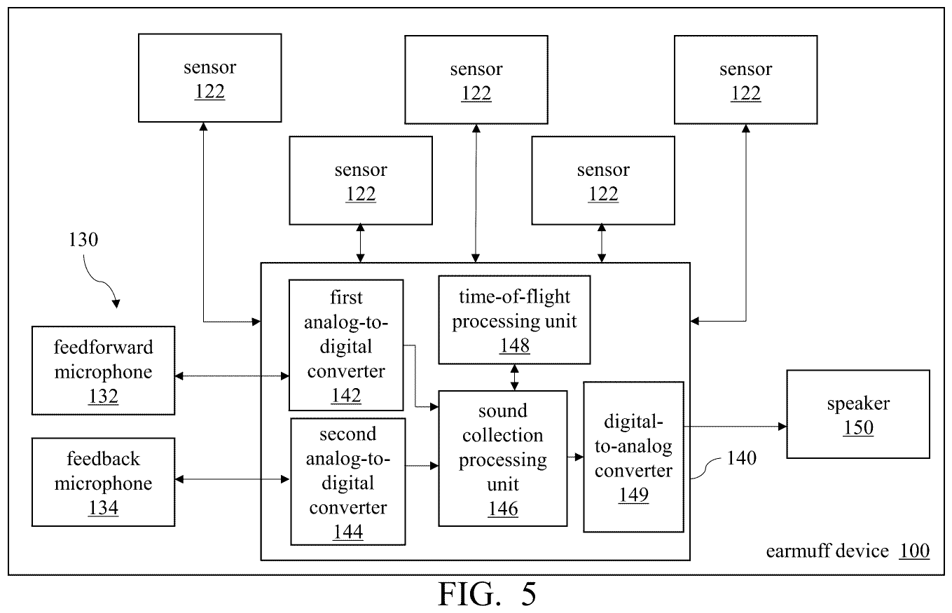

In one embodiment, the earmuff device 100 may further comprise a speaker 150 disposed in the accommodating cavity 112, and the speaker 150 is connected to the processor 140. The microphone unit 130 may comprise a feedforward microphone 132 and a feedback microphone 134, the feedforward microphone 132 and the feedback microphone 134 are disposed on opposite sides of the speaker 150, and the feedback microphone 134 is disposed between the sound output surface 152 of the speaker 150 and the sensing plate 120. In one embodiment, the processor 140 may further be configured to adjust gain values of the feedforward microphone 132 and the feedback microphone 134 respectively based on the magnitude relationship between the sensing amounts of the plurality of sensors 122 and the preset value. In another embodiment, the processor 140 may further be configured to adjust the gain value of the feedback microphone 134 based on the magnitude relationship between the sensing amounts of the plurality of sensors 122 and the preset value, and maintain the gain value of the feedforward microphone 132. The feedforward microphone 132 is configured to obtain an ambient noise signal, and the feedback microphone 134 is configured to obtain a noise signal close to the ear of the user. In addition, the processor 140 may comprise a first analog-to-digital converter 142 connected to the feedforward microphone 132, a second analog-to-digital converter 144 connected to the feedback microphone 134, and a sound collection processing unit 146, wherein the first analog-to-digital converter 142 performs analog-to-digital conversion on the ambient noise signal and outputs it to the sound collection processing unit 146, the second analog-to-digital converter 144 performs analog-to-digital conversion on the noise signal close to the ear of the user and outputs it to the sound collection processing unit 146, and the sound collection processing unit 146 is responsible for processing the received data, as shown in FIG. 5, which is a circuit block diagram of another embodiment of the earmuff device of FIG. 1.

In one embodiment, the gain values of the feedforward microphone 132 and the feedback microphone 134 may be the same or different.

In one embodiment, the earmuff device 100 may further comprise an ear pad 160, which is disposed on the side of the housing 110 that contacts the ear portion of the user (i.e., the front cover 114) and does not block the plurality of sensors 122. Since the material or thickness of the ear pad 160 may affect the sensing amount of the sensor 122, the material or thickness of the ear pad 160 may affect the setting of the preset value (i.e., the preset value is related to the material or thickness of the ear pad 160).

In one embodiment, one sensor 122 of the plurality of sensors 122 is disposed at a central portion 124 of the sensing plate 120, as shown in FIG. 4. The central portion 124 may be, but is not limited to, the geometric center of the shape of the sensing plate 120. As shown in FIG. 4, the shape of the sensing plate 120 may be circular, and the one sensor 122 is located at the central portion 124 of the sensing plate 120.

In one embodiment, the sensing plate 120 is provided with a mesh array 126, the mesh array 126 surrounds the central portion 124 of the sensing plate 120, other sensors 122 of the plurality of sensors 122 are disposed at a peripheral portion 128 of the sensing plate 120, and the peripheral portion 128 surrounds the mesh array 126. In other words, the sensing plate 120 comprises a mesh structure formed by a plurality of strip structures, and sound can be propagated through the mesh array 126 provided on the sensing plate 120. When the number of other sensors 122 of the plurality of sensors 122 is greater than or equal to two, other sensors 122 of the plurality of sensors 122 may be distributed in different areas of the peripheral portion 128. As shown in FIG. 4, the peripheral portion 128 may comprise a first area 128a, a second area 128b, a third area 128c, a fourth area 128d, and a fifth area 128e. The number of sensors 122 included in the earmuff device 100 may be five, one sensor 122 is disposed at the central portion 124 of the sensing plate 120, and the other four sensors 122 may be disposed in the first area 128a, the second area 128b, the third area 128c, and the fourth area 128d, respectively. However, this embodiment is not intended to limit the present disclosure, and the positions of the sensors 122 disposed in the peripheral portion 128 may be adjusted according to actual needs.

In one embodiment, the processor 140 may be further configured to adjust the gain value of the microphone unit 130 to a maximum preset gain value when it is determined that the sensing amount of the sensor 122 disposed only at the central portion 124 of the sensing plate 120 is greater than the preset value, and to adjust the gain value of the microphone unit 130 to a corresponding preset gain value based on the number of sensors 122 whose sensing amount being greater than the preset value, wherein the greater the number of sensors 122 whose sensing amount being greater than the preset value, the smaller the corresponding preset gain value.

For example, the corresponding preset gain value may comprise a first preset gain value, a second preset gain value and a maximum preset gain value, the maximum preset gain value is greater than the first preset gain value and the second preset gain value, and the second preset gain value is greater than the first preset gain value. Please refer to FIG. 3 and FIG. 4, if the processor 140 determines that the sensing amount of the sensor 122 located only in the central portion 124 of the sensing plate 120 is greater than the preset value, it means that the wearing tightness of the headphone 200 is not good, and the gain value of the microphone unit 130 is adjusted to the maximum preset gain value; if the processor 140 determines that the number of sensors 122 whose sensing amount is greater than the preset value is greater than three, it means that the wearing tightness of the headphone 200 is suboptimal, and the gain value of the microphone unit 130 is adjusted to the second preset gain value; if the processor 140 determines that the number of sensors 122 whose sensing amount is greater than the preset value is five, it means that the wearing tightness of the headphone 200 is good, and the gain value of the microphone unit 130 is adjusted to the first preset gain value.

In one embodiment, the processor 140 may be further configured to determine whether the headphone 200 is in the wearing state based on the sensing amount(s) of at least one sensor 122. When the sensing amount(s) of one or more sensors 122 is/are less than the preset value, the processor 140 determines that the headphone 200 is not in the wearing state. When the sensing amount(s) of one or more sensors 122 is/are greater than or equal to the preset value, the processor 140 determines that the headphone 200 is in the wearing state. In another embodiment, the processor 140 may be further configured to determine whether the headphone 200 is in the wearing state based on the sensing amount of the sensor 122 disposed at the central portion 124 of the sensing plate 120. When the sensing amount of the sensor 122 disposed at the central portion 124 of the sensing plate 120 is less than the preset value, the processor 140 determines that the headphone 200 is not in the wearing state. When the sensing amount of the sensor 122 disposed at the central portion 124 of the sensing plate 120 is greater than or equal to the preset value, the processor 140 determines that the headphone 200 is in the wearing state.

In one embodiment, the processor 140 may be further configured to turn off the plurality of sensors 122 when determining that the headphone 200 is not in the wearing state, thereby saving power consumption.

Since the processor 140 needs to turn on the plurality of sensors 122 when the user puts on the headphone 200 again, the earmuff device 100 may further determine whether the headphone 200 is in the wearing state during the period when the plurality of sensors 122 are turned off by combining the processor 140 with the speaker 150 and the feedback microphone 134, and then determine whether to turn on the plurality of sensors 122, as described in detail below.

In one embodiment, the processor 140 may be further configured to transmit different test audio signals corresponding to different time codes to the speaker in sequence for playing when it is determined that the headphone 200 is not in the wearing state, wherein any two consecutive test audio signals correspond to different frequencies. The feedback microphone 134 may be configured to receive different reflected audio signals after the different test audio signals are reflected by an object, and transmit the different reflected audio signals to the processor 140, so that the processor 140 obtains the time codes corresponding to the different reflected audio signals, and determines whether the headphone 200 is in the wearing state according to the time difference between the time point of transmitting each test audio signal and the time point of receiving the reflected audio signal corresponding to the time code corresponding to the each test audio signal. If the time difference is less than the preset time, the processor 140 determines that the headphone 200 is in the wearing state. If the time difference is greater than the preset time, the processor 140 determines that the headphone 200 is not in the wearing state. In other words, the earmuff device 100 may further determine whether the headphone 200 is in the wearing state by using the Time-of-Flight (TOF) principle through the processor 140 in combination with the speaker 150 and the feedback microphone 134 during the period when the plurality of sensors 122 are turned off.

Specifically, referring to FIG. 5, the processor 140 may further comprise a time-of-flight processing unit 148 and a digital-to-analog converter 149, wherein the time-of-flight processing unit 148 is connected to the sound collection processing unit 146, and the digital-to-analog converter 149 is connected to a speaker 150 and the sound collection processing unit 146. When the processor 140 determines that the headphone 200 is not in the wearing state, the time-of-flight processing unit 148 edits different test audios into different time codes, and transmits the different test audios corresponding to the different time codes to the sound collection processing unit 146 for processing in sequence. The different test audios processed by the sound collection processing unit 146 are converted by the digital-to-analog converter 149 and then transmitted to the speaker 150 for playing different test audio signals. The feedback microphone 134 may be further configured to receive different reflected audio signals after the different test audio signals are reflected by the object, and the different reflected audio signals are converted by the second analog-to-digital converter 144 and then transmitted to the sound collection processing unit 146 for frequency sampling. The different reflected audios obtained after sampling by the sound collection processing unit 146 are transmitted to the time-of-flight processing unit 148. The time-of-flight processing unit 148 obtains the corresponding time codes according to the different reflected audios received, and determines whether the headphone 200 is in the wearing state according to the time difference between the time point of transmitting each test audio and the time point of receiving the reflected audio corresponding to the time code corresponding to the each test audio.

In one embodiment, the processor 140 may be further configured to determine whether the headphone 200 is worn on a person based on the amplitude changes at the same frequencies in frequency spectrums of the test audio signal and the reflected audio signal corresponding to the same time code. It should be noted that the test audio signal is reflected by an object; since the sound absorbing coefficients of different objects may be different, and the sound absorbing coefficients of different objects may also be different at different frequencies, the amplitude of the reflected audio signal at frequencies where the human body has better sound absorption may change relative to the amplitude of the test audio signal at the same frequency.

In one embodiment, the processor 140 may be further configured to turn on the plurality of sensors 122 when it is determined in combination with the speaker 150 and the feedback microphone 134 that the headphone 200 is in the wearing state during the period when the plurality of sensors 122 are turned off. The processor 140 may be further configured to stop transmitting different test audio signals corresponding to different time codes to the speaker for playing in sequence when it is determined that the headphone 200 is in the wearing state. For example, the processor 140 stops the time-of-flight processing unit 148, and turns on the plurality of sensors 122. The processor 140 is configured to combine the speaker 150 and the feedback microphone 134 to determine that the headphone 200 is not in the wearing state during the period when the plurality of sensors 122 are turned off, and continue to determine whether the headphone 200 is in the wearing state by the above-mentioned time-of-flight principle.

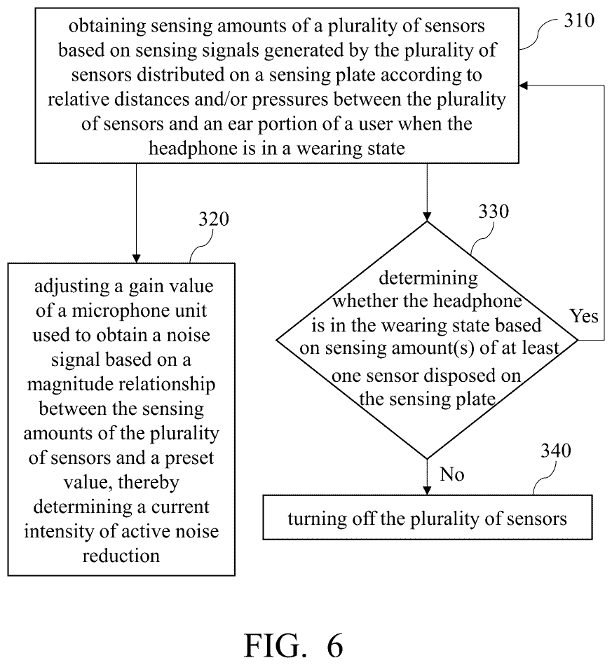

Please refer to FIG. 6, which is a flow chart of a noise reduction adjustment method according to an embodiment of the present disclosure. The noise reduction adjustment method of FIG. 6 may be applied to the earmuff device 100 of the headphone 200 of FIG. 3, and comprises the following steps: obtaining sensing amounts of a plurality of sensors 122 based on sensing signals generated by the plurality of sensors 122 distributed on a sensing plate 120 according to relative distances and/or pressures between the plurality of sensors 122 and an ear portion of a user when the headphone 200 is in a wearing state (step 310); and adjusting a gain value of a microphone unit 130 used to obtain a noise signal based on a magnitude relationship between the sensing amounts of the plurality of sensors 122 and a preset value, thereby determining a current intensity of active noise reduction (step 320). Therefore, the earmuff device 100 determines the wearing tightness, closeness and/or pressure of the headphone 200 through the sensing amounts of the plurality of sensors 122 (that is, the actual state of the headphone 200 is determined when it is worn on the ear portion), and automatically adjusts the gain value of the microphone unit 130 to improve the active noise reduction effect of the headphone 200.

In one embodiment, the step 320 may comprise: adjusting the gain value of the microphone unit 130 to a maximum preset gain value when it is determined that the sensing amount of the sensor 122 disposed only at a central portion 124 of the sensing plate 120 is greater than the preset value. The detailed description has been described in the above paragraphs and will not be repeated here.

In one embodiment, the step 320 may comprise: adjusting the gain value of the microphone unit 130 to a corresponding preset gain value based on the number of sensors 122 whose sensing amount being greater than the preset value, wherein the greater the number of sensors 122 whose sensing amount being greater than the preset value, the smaller the corresponding preset gain value. The detailed description has been described in the above paragraphs and will not be repeated here.

In one embodiment, the step 320 may comprise: adjusting gain values of a feedforward microphone 132 and a feedback microphone 134 included in the microphone unit 130 respectively based on the magnitude relationship between the sensing amounts of the plurality of sensors 122 and the preset value, or adjusting the gain value of the feedback microphone 134 based on the magnitude relationship between the sensing amounts of the plurality of sensors 122 and the preset value and maintaining the gain value of the feedforward microphone 132, wherein the feedforward microphone 132 and the feedback microphone 134 are disposed on opposite sides of a speaker 150, and the feedback microphone 132 is disposed between a sound output surface 152 of the speaker 150 and the sensing plate 120. The detailed description has been described in the above paragraphs and will not be repeated here.

In one embodiment, the noise reduction adjustment method may further comprise: determining whether the headphone 200 is in the wearing state based on sensing amount(s) of at least one sensor 122 disposed on the sensing plate 120 (step 330); determining that the headphone 200 is not in the wearing state when the sensing amount(s) of one or more sensors 122 disposed on the sensing plate 120 is/are less than the preset value, and turning off the plurality of sensors 122 (step 340), which can save power consumption. When the sensing amount(s) of one or more sensors 122 disposed on the sensing plate 120 is/are greater than or equal to the preset value, it is determined that the headphone 200 is in the wearing state, and step 310 is executed.

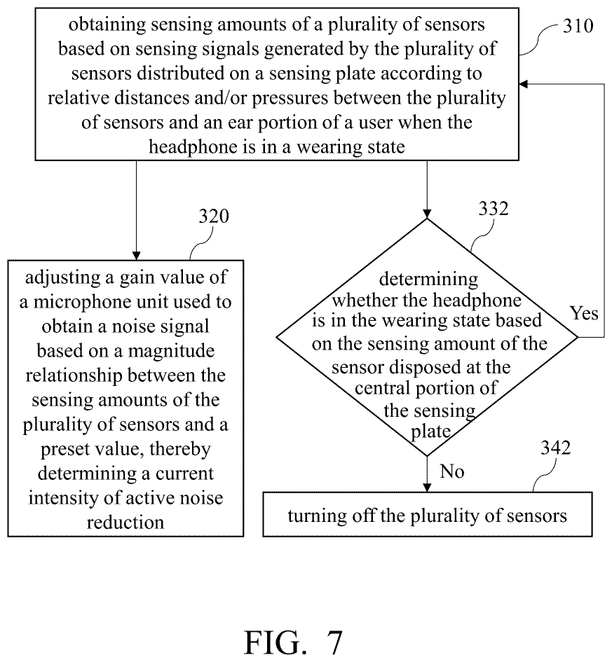

In one embodiment, please refer to FIG. 7, which is a flow chart of a noise reduction adjustment method according to another embodiment of the present disclosure. The noise reduction adjustment method of FIG. 7 can be applied to the earmuff device 100 of the headphone 200 of FIG. 3. In addition to step 310 to step 320, the noise reduction adjustment method of FIG. 7 may further comprise: determining whether the headphone 200 is in the wearing state based on the sensing amount of the sensor 122 disposed at the central portion 124 of the sensing plate 120 (step 332); determining that the headphone 200 is not in the wearing state when the sensing amount of the sensor 122 disposed at the central portion 124 of the sensing plate 120 is less than the preset value, and turning off the plurality of sensors 122 (step 342), which can save power consumption. When the sensing amount of the sensor 122 disposed at the central portion 124 of the sensing plate 120 is greater than or equal to the preset value, it is determined that the headphone 200 is in the wearing state, and step 310 is executed.

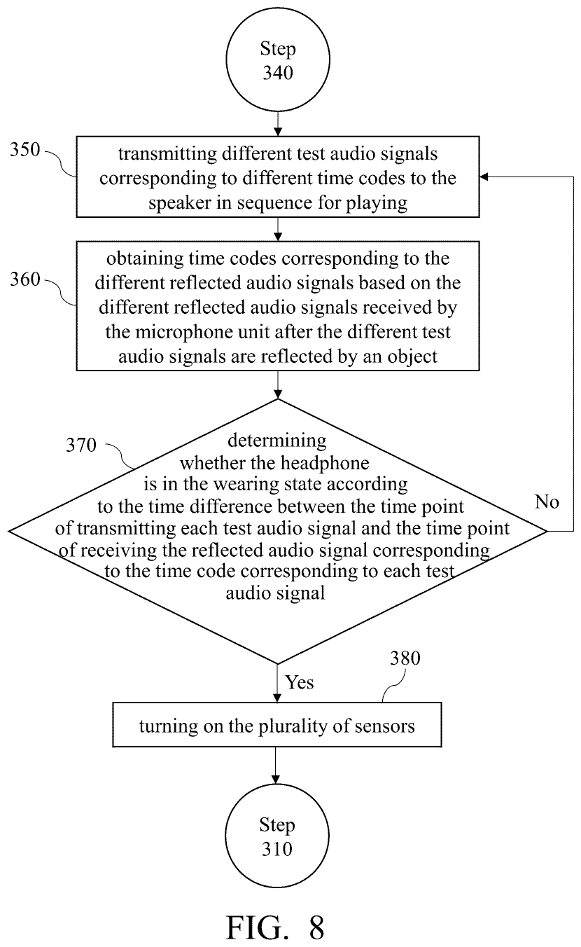

In one embodiment, please refer to FIG. 8, which is a flow chart of a noise reduction adjustment method according to still another embodiment of the present disclosure. As shown in FIG. 8, in addition to step 310 to step 340 in FIG. 6, the noise reduction adjustment method may further comprise: transmitting different test audio signals corresponding to different time codes to the speaker 150 in sequence for playing when it is determined that the headphone 200 is not in the wearing state and the plurality of sensors 122 are turned off (step 350), wherein any two consecutive test audio signals correspond to different frequencies; obtaining time codes corresponding to the different reflected audio signals based on the different reflected audio signals received by the microphone unit 130 after the different test audio signals are reflected by an object (step 360); determining whether the headphone 200 is in the wearing state according to the time difference between the time point of transmitting each test audio signal and the time point of receiving the reflected audio signal corresponding to the time code corresponding to each test audio signal (step 370); executing step 350 when it is determined that the headphone 200 is not in the wearing state; turning on the plurality of sensors 122 when it is determined that the headphone 200 is in the wearing state (step 380), and executing step 310. In order to avoid the drawing of FIG. 8 being too complicated, step 310 to step 330 in FIG. 6 are omitted. The detailed description has been described in the above paragraphs and will not be repeated here. In another embodiment, step 350 to step 380 can be performed after step 342 of FIG. 7.

In one embodiment, the noise reduction adjustment method may further comprise: determining whether the headphone 200 is worn on a person based on amplitude changes at the same frequencies in frequency spectrums of the test audio signal and the reflected audio signal corresponding to the same time code. The detailed description has been described in the above paragraphs and will not be repeated here.

In the earmuff device and the noise reduction adjustment method of the embodiments of the present disclosure, the sensing amounts of the plurality of sensors are used to determine the wearing tightness, closeness and/or pressure of the headphone (that is, the actual state of the headphone is determined when it is worn on the ear portion), and the gain value of the microphone unit is automatically adjusted to improve the active noise reduction effect of the headphone.

In summary, in the earmuff device, headphone and noise reduction adjustment method of the embodiments of the present disclosure, the wearing tightness, closeness and/or pressure of the headphone are determined by the sensing amounts of the plurality of sensors (that is, the actual state of the headphone is determined when it is worn on the ear portion), and the gain value of the microphone unit is automatically adjusted to improve the active noise reduction effect of the headphone. When the processor determines that the sensing amount of the sensor disposed only at the central portion of the sensing plate is greater than the preset value, the gain value of the microphone unit is adjusted to the maximum preset gain value. The gain value of the microphone unit is adjusted to the corresponding preset gain value based on the number of sensors whose sensing amount is greater than the preset value, wherein the greater the number of sensors whose sensing amount being greater than the preset value, the smaller the corresponding preset gain value. In addition, when the processor determines that the headphone is not in the wearing state based on the sensing amount(s) of at least one sensor disposed on the sensing plate, the plurality of sensors are turned off to save power consumption. Besides, the processor can turn on the plurality of sensors when it is determined in combination with the speaker and the feedback microphone that the headphone is in the wearing state during the period when the plurality of sensors are turned off; when the processor can combine the speaker and the feedback microphone to determine that the headphone is not in the wearing state during the period when the plurality of sensors are turned off, and the processor continues to determine whether the headphone is in the wearing state by the above-mentioned time-of-flight principle.

While the present disclosure is disclosed in the foregoing embodiments, it should be noted that these descriptions are not intended to limit the present disclosure. On the contrary, the present disclosure covers modifications and equivalent arrangements obvious to those skilled in the art. Therefore, the scope of the claims must be interpreted in the broadest manner to comprise all obvious modifications and equivalent arrangements.

What is claimed is:

1. An earmuff device applied to a headphone and comprising:
a housing provided with an accommodation cavity;
a sensing plate disposed in the accommodation cavity and provided with a plurality of sensors distributed at different positions, each of the plurality of sensors being configured to generate a sensing signal according to a relative distance and/or a pressure between each sensor and an ear portion of a user when the headphone is in a wearing state;
a microphone unit disposed in the accommodation cavity and configured to obtain an ambient noise signal; and
a processor disposed in the accommodation cavity, connected to the plurality of sensors and the microphone unit, and configured to obtain sensing amounts of the plurality of sensors based on the sensing signals generated by the plurality of sensors, and adjust a gain value of the microphone unit based on a magnitude relationship between the sensing amounts of the plurality of sensors and a preset value, so as to determine a current intensity of active noise reduction.

2. The earmuff device according to claim 1, wherein one sensor of the plurality of sensors is disposed at a central portion of the sensing plate.

3. The earmuff device according to claim 2, wherein the sensing plate is provided with a mesh array, the mesh array surrounds the central portion of the sensing plate, other sensors of the plurality of sensors are disposed at a peripheral portion of the sensing plate, and the peripheral portion surrounds the mesh array.

4. The earmuff device according to claim 3, wherein the processor is further configured to adjust the gain value of the microphone unit to a maximum preset gain value when it is determined that the sensing amount of the sensor disposed only at the central portion of the sensing plate is greater than the preset value, and to adjust the gain value of the microphone unit to a corresponding preset gain value based on the number of the sensors whose sensing amount being greater than the preset value, wherein the greater the number of the sensors whose sensing amount being greater than the preset value, the smaller the corresponding preset gain value.

5. The earmuff device according to claim 2, wherein the processor is further configured to determine whether the headphone is in the wearing state based on sensing amount(s) of at least one sensor of the plurality of sensors.

6. The earmuff device according to claim 5, wherein the processor is further configured to turn off the plurality of sensors when it is determined that the headphone is not in the wearing state.

7. The earmuff device according to claim 6, further comprising a speaker disposed in the accommodating cavity and connected to the processor; wherein the processor is further configured to transmit different test audio signals corresponding to different time codes to the speaker in sequence for playing when it is determined that the headphone is not in the wearing state and the plurality of sensors are turned off, and any two consecutive test audio signals correspond to different frequencies; the microphone unit comprises a feedback microphone, and the feedback microphone is configured to receive different reflected audio signals after the different test audio signals are reflected by an object, and transmit the different reflected audio signals to the processor, so that the processor obtains time codes corresponding to the different reflected audio signals, and determines whether the headphone is in the wearing state according to a time difference between a time point of transmitting each test audio signal and a time point of receiving the reflected audio signal corresponding to the time code corresponding to the each test audio signal.

8. The earmuff device according to claim 7, wherein the processor is further configured to determine whether the headphone is worn on a person based on amplitude changes at the same frequencies in frequency spectrums of the test audio signal and the reflected audio signal corresponding to the same time code.

9. The earmuff device according to claim 7, wherein the processor is further configured to turn on the plurality of sensors when it is determined that the headphone is in the wearing state according to the time difference.

10. The earmuff device according to claim 1, further comprising a speaker disposed in the accommodating cavity and connected to the processor; wherein the microphone unit comprises a feedforward microphone and a feedback microphone, the feedforward microphone and the feedback microphone are disposed on opposite sides of the speaker, and the feedback microphone is disposed between a sound output surface of the speaker and the sensing plate; the processor is configured to adjust gain values of the feedforward microphone and the feedback microphone respectively based on the magnitude relationship between the sensing amounts of the plurality of sensors and the preset value, or the processor is configured to adjust the gain value of the feedback microphone based on the magnitude relationship between the sensing amounts of the plurality of sensors and the preset value and maintain the gain value of the feedforward microphone.

11. The earmuff device according to claim 1, further comprising an ear pad, which is disposed on a side of the housing that contacts the ear portion of the user, and does not block the plurality of sensors, wherein the preset value is related to a material or thickness of the ear pad.

12. A noise reduction adjustment method applied to an earmuff device of a headphone and comprising the following steps:
obtaining sensing amounts of a plurality of sensors based on sensing signals generated by the plurality of sensors distributed on a sensing plate according to relative distances and/or pressures between the plurality of sensors and an ear portion of a user when the headphone is in a wearing state; and
adjusting a gain value of a microphone unit used to obtain an ambient noise signal based on a magnitude relationship between the sensing amounts of the plurality of sensors and a preset value, thereby determining a current intensity of active noise reduction.

13. The noise reduction adjustment method according to claim 12, wherein the step of adjusting the gain value of the microphone unit used to obtain the ambient noise signal based on the magnitude relationship between the sensing amounts of the plurality of sensors and the preset value comprises:
adjusting the gain value of the microphone unit to a maximum preset gain value when it is determined that the sensing amount of the sensor disposed only at a central portion of the sensing plate is greater than the preset value.

14. The noise reduction adjustment method according to claim 12, wherein the step of adjusting the gain value of the microphone unit used to obtain the ambient noise signal based on the magnitude relationship between the sensing amounts of the plurality of sensors and the preset value comprises:
adjusting the gain value of the microphone unit to a corresponding preset gain value based on the number of the sensors whose sensing amount being greater than the preset value, wherein the greater the number of the sensors whose sensing amount being greater than the preset value, the smaller the corresponding preset gain value.

15. The noise reduction adjustment method according to claim 12, further comprising:
determining whether the headphone is in the wearing state based on sensing amount(s) of at least one sensor of the plurality of sensors.

16. The noise reduction adjustment method according to claim 12, further comprising:
turning off the plurality of sensors when it is determined that the headphone is not in the wearing state.

17. The noise reduction adjustment method according to claim 16, further comprising:
transmitting different test audio signals corresponding to different time codes to a speaker in sequence for playing when it is determined that the headphone is not in the wearing state and the plurality of sensors are turned off, wherein any two consecutive test audio signals correspond to different frequencies;
obtaining time codes corresponding to different reflected audio signals based on the different reflected audio signals received by the microphone unit after the different test audio signals are reflected by an object; and
determining whether the headphone is in the wearing state according to a time difference between a time point of transmitting each test audio signal and a time point of receiving the reflected audio signal corresponding to the time code corresponding to the each test audio signal.

18. The noise reduction adjustment method according to claim 17, further comprising:
determining whether the headphone is worn on a person based on amplitude changes at the same frequencies in frequency spectrums of the test audio signal and the reflected audio signal corresponding to the same time code.

19. The noise reduction adjustment method according to claim 17, further comprising:
turning on the plurality of sensors when it is determined that the headphone is in the wearing state according to the time difference.

20. The noise reduction adjustment method according to claim 12, wherein the step of adjusting the gain value of the microphone unit used to obtain the ambient noise signal based on the magnitude relationship between the sensing amounts of the plurality of sensors and the preset value comprises:
adjusting gain values of a feedforward microphone and a feedback microphone included in the microphone unit respectively based on the magnitude relationship between the sensing amounts of the plurality of sensors and the preset value, or adjusting the gain value of the feedback microphone based on the magnitude relationship between the sensing amounts of the plurality of sensors and the preset value and maintaining the gain value of the feedforward microphone, wherein the feedforward microphone and the feedback microphone are disposed on opposite sides of a speaker, and the feedback microphone is disposed between a sound output surface of the speaker and the sensing plate.
